(19) United States
(12) Patent Application Publication
(10) Pub. No.: US 2025/0179275 A1
(43) Pub. Date: Jun. 5, 2025

(54) TIRE RUBBER COMPOSITION

(71) Applicant: The Yokohama Rubber Co., LTD., Kanagawa (JP)

(72) Inventors: Ryutaro NAKAGAWA, Kanagawa (JP); Kaori OSUMI, Kanagawa (JP); Kentaro TAKEUCHI, Kanagawa (JP)

(21) Appl. No.: 18/846,146

(22) PCT Filed: Mar. 14, 2023
(86) PCT No.: PCT/JP2023/009843

§ 371 Date: Sep. 11, 2024

(30) Foreign Application Priority Data
Mar. 16, 2022 (JP) 2022-041018

(51) Int. Cl. C08L 9/06; B60C 1/00; C08K 3/36

(52) U.S. Cl. CPC C08L 9/06; B60C 1/0016; C08K 3/36

(57) ABSTRACT

A rubber composition for a tire contains: 100 parts by mass of a diene rubber containing ≥55 mass % of styrene-butadiene rubber; and ≥15 parts by mass of thermoplastic resin. The styrene-butadiene rubber has a glass transition temperature of ≤−55° C. and a total amount of a styrene monomer-derived unit and a vinyl monomer-derived unit of ≤50 mol %. Tga−Tgm≤10° C., where Tga is a theoretical glass transition temperature of a mixture of the diene rubber and the thermoplastic resin, blended at a mass ratio of 1:1, and Tgm is a measured glass transition temperature of the mixture. tan δ_{MAXA}/tan δ_{MAXB}>0.8 is satisfied, where tan δ_{MAXA} is a loss tangent maximum value at −40° C. to 60° C. of the rubber composition and tan δ_{MAXB} is a loss tangent maximum value at −40° C. to 60° C. of a rubber composition B where the thermoplastic resin of the rubber composition is replaced with oil.

### TECHNICAL FIELD

The present technology relates to a rubber composition for a tire having excellent wear resistance, dry performance, and wet performance and intended for a high-performance tire.

### BACKGROUND ART

A high-performance type tire is required to have high levels of wear resistance, dry performance, and wet performance. It is also required to maintain grip performance even after long-term use. For the rubber composition for a tire which has improved wet performance and wear resistance, blending of an aromatic modified terpene resin in a rubber composition for a tire has been proposed (e.g., see Japan Unexamined Patent Publication No. 2013-166864 A).

However, the technology described in Japan Unexamined Patent Publication No. 2013-166864 A is not necessarily sufficient to maintain excellent dry performance and grip performance at a high level after long-term use.

### SUMMARY

The present technology provides a rubber composition for a tire having excellent wear resistance, dry performance, and wet performance and maintaining grip performance at a high level even after long-term use.

A rubber composition for a tire according to an embodiment of the present technology is a rubber composition for a tire, containing: 100 parts by mass of a diene rubber containing 55 mass % or more of a styrene-butadiene rubber; and 15 parts by mass or more of a thermoplastic resin, the styrene-butadiene rubber having a glass transition temperature of −55° C. or lower, a total amount of a styrene monomer-derived unit and a vinyl monomer-derived unit in the styrene-butadiene rubber being 50 mol % or lower, and the diene rubber and the thermoplastic resin satisfying relationships (i) and (ii) below:
(i) a difference Tga−Tgm between Tga and Tgm is 10° C. or less, where Tga is a theoretical glass transition temperature of a mixture in which the diene rubber and the thermoplastic resin are blended at a mass ratio of 1:1, the theoretical glass transition temperature Tga of the mixture being calculated from glass transition temperatures of the diene rubber and the thermoplastic resin, and Tgm is a measured glass transition temperature of the mixture; and
(ii) a maximum value tan δ_{MAXA} of a loss tangent at from −40° C. to 60° C. of the rubber composition for a tire and a maximum value tan δ_{MAXB} of a loss tangent at from −40° C. to 60° C. of a rubber composition B having the same composition as that of the rubber composition for a tire except that all the thermoplastic resin is replaced with oil satisfy Formula (1) below in relation to the rubber composition B:

$$tan {δ}_{MAXA} / tan {δ}_{MAXB} > 0.8 \qquad ( 1 )$$

Because the specific thermoplastic resin is blended in the diene rubber containing the specific styrene-butadiene rubber in the rubber composition for a tire of the present technology, excellent wear resistance, dry performance, and wet performance can be achieved and grip performance can be maintained at a high level even after long-term use.

A total amount of the oil contained in the rubber composition for a tire is preferably less than 10 parts by mass per 100 parts by mass of the diene rubber.

At least one terminal of the styrene-butadiene rubber is preferably modified with a functional group, and an oil extension amount of the styrene-butadiene rubber is preferably 10 parts by mass or less per 100 parts by mass of the styrene-butadiene rubber.

The thermoplastic resin preferably has a glass transition temperature of from 40° C. to 120° C., and is preferably at least one selected from the group consisting of resins composed of at least one selected from terpenes, terpene phenols, rosins, rosin esters, C5 components, and C9 components, and resins in which at least some of double bonds of these resins are hydrogenated.

A tire including a tread portion containing the rubber composition for a tire described above is particularly suitable as a high-performance tire, has excellent wear resistance, dry performance, and wet performance, and can maintain grip performance at a high level even after long-term use.

### DETAILED DESCRIPTION

The rubber composition for a tire according to an embodiment of the present technology contains diene rubber as a rubber component, which contains 55 mass % or more of a specific styrene-butadiene rubber in 100 mass % of the diene rubber. Blending of the specific styrene-butadiene rubber can make dispersibility of silica good, increase tensile strength at break, wear resistance, and tan δ at 0° C., and make wet performance excellent. The amount of the specific styrene-butadiene rubber is 55 mass % or more, preferably from 55 to 80 mass %, and more preferably from 60 to 75 mass %, in 100 mass % of the diene rubber. When the amount of the specific styrene-butadiene rubber is less than 55 mass %, an effect of enhancing dispersibility of the silica cannot be adequately achieved, and the wear resistance and wet performance cannot be improved satisfactorily.

A glass transition temperature (hereinafter sometimes referred to as “Tg”) of the specific styrene-butadiene rubber is preferably −55° C. or lower, from −80° C. to −58° C., and more preferably from −75° C. to −60° C. When the Tg of the styrene-butadiene rubber is higher than −55° C., wear resistance is deteriorated. For the Tg of the styrene-butadiene rubber, differential scanning calorimetry (DSC) is performed at a rate of temperature increase of 20° C./minute to obtain a thermogram, and the temperature at the midpoint of the transition region is defined as the glass transition temperature. When the diene rubber is an oil extended product, the Tg is the Tg of the diene rubber containing no oil-extending component (oil).

A total amount of the styrene monomer-derived unit and the vinyl monomer-derived unit contained in the specific styrene-butadiene rubber is 50 mol % or less, preferably from 10 to 50 mol %, and more preferably from 15 to 50 mol %. When the total amount of the styrene monomer-derived unit and the vinyl monomer-derived unit exceeds 50 mol %, Tg tends to be high and wear resistance is deteriorated. In the present specification, the styrene monomer-derived unit is a repeating unit derived from a styrene monomer among repeating units constituting the styrene-butadiene rubber. The vinyl monomer-derived unit is a repeating unit formed by 1,2-bonding of a butadiene monomer among the repeating units constituting the styrene-butadiene rubber. The 1,2-bonded butadiene monomer is referred to herein as a vinyl monomer because its repeating unit is in the form of vinyl ethylene (—CH₂—CH(CH═CH₂)—). The amounts (mol %) of the styrene monomer-derived unit and the vinyl monomer-derived unit in the styrene-butadiene rubber can be measured by 1H-NMR.

A content of the styrene monomer-derived unit in the styrene-butadiene rubber is not particularly limited and is preferably from 5 to 45 mol %, and more preferably from 8 to 42 mol %. The content of the styrene monomer-derived unit in this range is preferred because good wear resistance is achieved.

The content of the vinyl monomer-derived unit in the styrene-butadiene rubber is not particularly limited and is preferably from 5 to 45 mol %, and more preferably from 8 to 42 mol %. The content of the styrene monomer-derived unit in this range is preferred because dry grip performance can be maintained at a high level even after long-term use.

The content of the styrene monomer-derived unit in the styrene-butadiene rubber is preferably higher than the content of the vinyl monomer-derived unit. When the content of the styrene monomer-derived unit is higher and the total amount of the styrene monomer-derived unit and the vinyl monomer-derived unit is 50 mol % or less, a good balance between wear resistance and dry grip performance is achieved, which is preferable.

In an embodiment of the present technology, at least one terminal of the specific styrene-butadiene rubber is preferably modified with a functional group, which can make the dispersibility of the silica good and further reduce the rolling resistance of the tire. Examples of the functional group include epoxy group, carboxy group, amino group, hydroxy group, alkoxy group, silyl group, alkoxysilyl group, amide group, oxysilyl group, silanol group, isocyanate group, isothiocyanate group, carbonyl group, and aldehyde group. Among them, a functional group having a polyorganosiloxane structure or an aminosilane structure is preferable. The presence of the functional group having the polyorganosiloxane structure or the aminosilane structure can make the dispersibility of the silica good, and make wear resistance, dry performance, and wet performance excellent.

The styrene-butadiene rubber may contain an oil-extending component. The oil extension amount of the styrene-butadiene rubber is preferably 10 parts by mass or less per 100 parts by mass of the styrene-butadiene rubber. By setting the oil extension amount to 10 parts by mass or less, it is possible to suppress deterioration in grip performance after aging of the tire. The oil extension amount is more preferably 8 parts by mass or less, and even more preferably 5 parts by mass or less.

The rubber composition for a tire may contain, as a rubber component, another diene rubber besides the specific styrene-butadiene rubber. Examples of the other diene rubber can include a styrene-butadiene rubber having a Tg of higher than −55° C., a styrene-butadiene rubber having a total amount of a styrene monomer-derived unit and a vinyl monomer-derived unit of more than 50 mol %, natural rubber, isoprene rubber, butadiene rubber, butyl rubber, halogenated butyl rubber, acrylonitrile-butadiene rubber, and modified rubbers obtained by adding a functional group to these rubbers. The other diene rubber may be used alone or as a discretionary blend. The content of the other diene rubber is preferably 45 mass % or less, more preferably from 20 to 45 mass %, and even more preferably from 25 to 40 mass % in 100 mass % of the diene rubber.

The rubber composition for a tire preferably contains a styrene-butadiene rubber having a Tg of higher than −55° C. because good wet performance is achieved. The amount of the styrene-butadiene rubber having a Tg of higher than −55° C. is preferably from 3 to 45 mass %, and more preferably from 5 to 35 mass %, in 100 mass % of the diene rubber. As the styrene-butadiene rubber having a Tg of higher than −55° C., a solution-polymerized styrene-butadiene rubber that is ordinarily used in a rubber composition for a tire may be used.

The rubber composition for a tire preferably contains a natural rubber because good wear resistance is achieved. The amount of the natural rubber is preferably from 5 to 35 mass %, and more preferably from 10 to 30 mass %, in 100 mass % of the diene rubber. As the natural rubber, a natural rubber that is ordinarily used in a rubber composition for a tire is preferably used.

Furthermore, blending of butadiene rubber is preferred because good wear resistance is achieved. The amount of the butadiene rubber is preferably from 2 to 25 mass %, and more preferably from 4 to 20 mass %, in 100 mass % of the diene rubber. As the butadiene rubber, a natural rubber that is ordinarily used in a rubber composition for a tire is preferably used.

The rubber composition for a tire can contain a white filler in the diene rubber. Blending of the white filler can improve wet performance. Examples of the white filler include silica, calcium carbonate, magnesium carbonate, talc, clay, alumina, aluminum hydroxide, titanium oxide, and calcium sulfate. One type of these can be used alone, or a combination of two or more types of these can be used. Among them, silica is preferable, and the wet performance and the low heat build-up property can be made more excellent. The white filler is preferably blended in an amount of preferably 300 parts by mass or less, more preferably 250 parts by mass or less, and even more preferably 200 parts by mass or less in 100 parts by mass of the diene rubber. The white filler is preferably blended in an amount of preferably 10 parts by mass or more, more preferably 25 parts by mass or more, and even more preferably 50 parts by mass or more per 100 parts by mass of the diene rubber.

As the silica, silica ordinarily used in a rubber composition for a tire is preferably used. For example, wet silica, dry silica, carbon-silica in which silica is carried on a carbon black surface (dual-phase filler), and silica that is surface-treated with a compound having reactivity or miscibility with both silica and rubber, such as a silane coupling agent or polysiloxane, can be used. Among these, a wet silica having hydrous silicic acid as a main component is preferred.

Furthermore, blending a silane coupling agent together with the silica is preferred because dispersibility of the silica is improved, and the wet performance and the low heat build-up property are further improved. The type of silane coupling agent is not particularly limited and is preferably a sulfur-containing silane coupling agent, and examples thereof can include bis-(3-triethoxysilylpropyl)tetrasulfide, bis(3-triethoxysilylpropyl)trisulfide, bis(3-triethoxysilylpropyl)disulfide, bis(2-triethoxysilylethyl)tetrasulfide, bis(3-trimethoxysilylpropyl)tetrasulfide, bis(2-triethoxysilylethyl)tetrasulfide, 3-mercaptopropyltrimethoxysilane, 3-mercaptopropyldimethoxymethylsilane, 3-mercaptopropyldimethylmethoxysilane, 2-mercaptoethyltriethoxysilane, 3-mercaptopropyltriethoxysilane, mercaptosilane compounds exemplified in JP 2006-249069 A such as VP Si363 available from Evonik Co., 3-trimethoxysilylpropylbenzothiazole tetrasulfide, 3-triethoxysilylpropylbenzothiazolyl tetrasulfide, 3-triethoxysilylpropylmethacrylate monosulfide, 3-trimethoxysilylpropylmethacrylate monosulfide, 3-triethoxysilylpropyl-N,N-dimethylthiocarbamoyl tetrasulfide, 3-trimethoxysilylpropyl-N,N-dimethylthiocarbamoyl tetrasulfide, 2-triethoxysilylethyl-N,N-dimethylthiocarbamoyl tetrasulfide, bis(3-diethoxymethylsilylpropyl) tetrasulfide, dimethoxymethylsilylpropyl-N,N-dimethylthiocarbamoyl tetrasulfide, dimethylmethylsilylpropylbenzothiazolyl tetrasulfide, 3-octanoylthiopropyltriethoxysilane, 3-propionylthiopropyltrimethoxysilane, vinyltrimethoxysilane, vinyltriethoxysilane, vinyltris(2-methoxyethoxy)silane, 3-glycidoxypropyltrimethoxysilane, 3-glycidoxypropylmethyldimethoxysilane, β-(3,4-epoxycyclohexyl)ethyltrimethoxysilane, 3-aminopropyltrimethoxysilane, N-(β-aminoethyl)-γ-aminopropyltrimethoxysilane, and N-(β-aminoethyl)-γ-aminopropylmethyldimethoxysilane.

The blended amount of the silane coupling agent is from 3 to 20 mass %, and preferably from 5 to 15 mass %, relative to the mass of the silica. When the blended amount of the silane coupling agent is less than 3 mass % of the silica mass, the effect of improving the dispersibility of the silica cannot be adequately achieved. Furthermore, when the blended amount of the silane coupling agent is more than 20 mass %, the diene rubber component tends to be gelled, and thus the desired effect cannot be achieved.

By blending another filler besides the white filler in the rubber composition for a tire, the strength of the rubber composition can be made high, and tire durability can be ensured. Examples of the other filler include an inorganic filler such as carbon black, mica, aluminum oxide, and barium sulfate; and an organic filler such as cellulose, lecithin, lignin, and dendrimer.

In particular, by blending the carbon black, excellent strength of the rubber composition can be achieved. As the carbon black, a carbon black such as furnace black, acetylene black, thermal black, channel black, and graphite can be blended. Of these, furnace black is preferred. Specific examples thereof include SAF (Super Abrasion Furnace), ISAF (Intermediate Super Abrasion Furnace), ISAF-HS (Intermediate Super Abrasion Furnace-High Structure), ISAF-LS (Intermediate Super Abrasion Furnace-Low Structure), IISAF-HS (Intermediate Intermediate Super Abrasion Furnace-High Structure), HAF (High Abrasion Furnace), HAF-HS (High Abrasion Furnace-High Structure), HAF-LS (High Abrasion Furnace-Low Structure), and FEF (Fast Extruding Furnace). One type of these carbon blacks may be used alone, or a combination of two or more types of these carbon blacks may be used. Furthermore, surface-treated carbon blacks, in which these carbon blacks are chemically modified with various acid compounds, can also be used.

When the rubber composition for a tire contains the specific thermoplastic resin, the temperature dependency of dynamic visco-elasticity can be adjusted. The specific thermoplastic resin is blended in an amount of 15 parts by mass or more, preferably 20 parts by mass or more, and more preferably 25 parts by mass or more per 100 parts by mass of the diene rubber. When the amount of the thermoplastic resin is less than 15 parts by mass, achieving excellent wear resistance, dry performance, and wet performance and maintaining grip performance at a high level even after long-term use, cannot be achieved. Also, the specific thermoplastic resin is blended in an amount of preferably 150 parts by mass or less, and more preferably 120 parts by mass or less per 100 parts by mass of the diene rubber. When the amount of the specific thermoplastic resin is more than 120 parts by mass, wear resistance may deteriorate.

The specific thermoplastic resin satisfies a relationship (i) below with the diene rubber.

(i) A difference Tga−Tgm between Tga and Tgm is 10° C. or less, where Tga is a theoretical glass transition temperature of a mixture in which the diene rubber and the thermoplastic resin described above are blended at a mass ratio of 1:1, the theoretical glass transition temperature Tga of the mixture being calculated from glass transition temperatures of the diene rubber and the thermoplastic resin, and Tgm is a measured glass transition temperature of the mixture.

By having the difference Tga−Tgm be 10° C. or less, the wear resistance and the wet performance can be excellent, the rolling resistance can be reduced, and the temperature dependency of the rolling resistance can be reduced. The difference Tga−Tgm is preferably 7° C. or less, and more preferably 5° C. or less. When the difference Tga−Tgm is 10° C. or less, it is considered that the diene rubber and the thermoplastic resin are in a compatible relationship, and that, by blending a relatively large amount of the thermoplastic resin, the tensile strength at break of the rubber composition is increased, which contributes to improvement in visco-elastic properties such as tan δ. In the present specification, the theoretical glass transition temperature (Tga) of the mixture can be calculated as a weighted average value based on the glass transition temperatures and the mass ratio of the diene rubber and the thermoplastic resin. The glass transition temperatures (Tg) of the diene rubber and the thermoplastic resin, and the glass transition temperature (Tgm) of the mixture, are measured values obtained by performing differential scanning calorimetry (DSC) at a rate of temperature increase of 20° C./min to obtain a thermogram and thereby obtain the temperature at the midpoint of the transition region as the glass transition temperatures Tg or Tgm. When there is a plurality of transition regions in the thermogram, the midpoint in the largest transition region is taken as the glass transition temperature Tgm of the mixture.

Further, the specific thermoplastic resin satisfies a relationship (ii) below with the diene rubber.

(ii) When the rubber composition for a tire according to an embodiment of the present technology is referred to as rubber composition A, a rubber composition having the same composition as that of the rubber composition A except that all the thermoplastic resin contained in the rubber composition A is replaced with oil is referred to as rubber composition B, a maximum value of a loss tangent at from −40° C. to 60° C. of the rubber composition A is referred to as tan δ_{MAXA}, and a maximum value of a loss tangent at from −40° C. to 60° C. of the rubber composition B is referred to as tan δ_{MAXB}, the tan δ_{MAXA} and the tan δ_{MAXB} satisfy the relationship of Formula (1) below:

tan δ_{MAXA}/tan δ_{MAXB}>0.8 (1)

When a ratio tan δ_{MAXA}/tan δ_{MAXB} between the maximum values of the loss tangents is more than 0.8, the tensile strength at break of the rubber composition for a tire of the present technology (rubber composition A) becomes large, and the wear resistance when it is formed into a tire becomes more excellent. The rubber composition B tends to have high compatibility between the diene rubber and the oil contained therein and high tensile strength at break. When the tan δ_{MAXA} of the rubber composition A is close to the tan δ_{MAXB} of the rubber composition B, it is inferred that the visco-elastic behaviors of the rubber compositions are similar to each other, that the compatibility between the diene rubber and the thermoplastic resin is good, that the thermoplastic resin is prevented from becoming a starting point of breakage, and that the tensile strength at break is increased. The ratio tan δ_{MAXA}/tan δ_{MAXB} is more preferably more than 0.85 and even more preferably more than 0.9. In the present specification, the tan δ_{MAXA} and the tan δ_{MAXB} can be obtained by measuring the dynamic visco-elasticity of cured products of the rubber compositions A and B using a visco-elastic spectrometer under conditions of an elongation deformation strain rate of 10±2%, a vibration frequency of 20 Hz, and a temperature of from −40° C. to 60° C., obtaining a visco-elastic curve with the measurement temperature on the horizontal axis and the loss tangent (tan δ) on the vertical axis, and taking thickest values (peak values) of the tan δ as tan δ_{MAXA} and tan δ_{MAXB}, respectively.

The thermoplastic resin is a resin usually blended in a rubber composition for a tire, has a molecular weight of about several hundreds to several thousands, and has a function of imparting adhesiveness to the rubber composition for a tire. The thermoplastic resin is preferably a resin composed of at least one selected from the group consisting of resins composed of at least one selected from terpenes, modified terpenes, rosins, rosin esters, C5 components, and C9 components, and resins in which at least some of double bonds of these resins are hydrogenated. Examples of the resin include natural resins such as a terpene resins, modified terpene resins, rosin resins, and rosin ester resins, synthetic resins such as petroleum resins including C5 components and C9 components, coal resins, phenol resins, and xylene resins, and hydrogenated resins obtained by hydrogenating at least some of double bonds of these natural resins and synthetic resins.

Examples of the terpene resins include α-pinene resin, β-pinene resin, limonene resin, hydrogenated limonene resin, dipentene resin, terpene phenol resin, terpene styrene resin, aromatic modified terpene resin, and hydrogenated terpene resin. Examples of the rosin resins include modified rosins such as gum rosin, tall oil rosin, wood rosin, hydrogenated rosin, disproportionate rosin, polymerized rosin, maleated rosin, and fumarized rosin; ester derivatives of these rosins such as glycerine esters, pentaerythritol esters, methyl esters, and triethylene glycol esters; and rosin modified phenol resin.

Examples of the petroleum resin include aromatic hydrocarbon resins or, alternatively, saturated or unsaturated aliphatic hydrocarbon resins. Examples thereof include C5 petroleum resins (aliphatic petroleum resins formed by polymerizing fractions such as isoprene, 1,3-pentadiene, cyclopentadiene, methylbutene, pentene, and the like), C9 petroleum resins (aromatic petroleum resins formed by polymerizing fractions such as α-methylstyrene, o-vinyl toluene, m-vinyl toluene, p-vinyl toluene, and the like), C5C9 copolymerization petroleum resins, and resins obtained by hydrogenating these resins.

The glass transition temperature (Tg) of the thermoplastic resin is preferably from 40° C. to 120° C., preferably from 45° C. to 115° C., and more preferably from 50° C. to 110° C. A Tg of the thermoplastic resin of 40° C. or higher is preferred because dry grip performance is improved. Additionally, a Tg of 120° C. or lower of the thermoplastic resin is preferred because wear resistance is improved. The Tg of the thermoplastic resin can be measured by the method described above.

In addition to the components described above, the rubber composition for a tire may also contain various compounding agents that are commonly used in rubber compositions for a tire, in accordance with an ordinary method. Examples of the compounding agents include a vulcanization or crosslinking agent, a vulcanization accelerator, an anti-aging agent, a processing aid, a plasticizer, a liquid polymer, and a thermosetting resin. These compounding agents can be kneaded by a common method to obtain a rubber composition that can then be used for vulcanization or crosslinking. These compounding agents can be compounded in known general amounts so long as the present technology is not hindered. The rubber composition for a tire can be prepared by mixing the above-mentioned components using a known rubber kneading machine such as a Banbury mixer, a kneader, or a roller.

The rubber composition for a tire is suitable for forming a tread portion or a side portion of a high-performance tire and especially suitable for forming a tread portion of a high-performance tire. The thus obtained high-performance tire can have excellent wear resistance, dry performance, and wet performance and maintain grip performance at a high level even after long-term use.

Embodiments according to the present technology are further described below by Examples. However, the scope of the present technology is not limited to these Examples.

### Examples

For preparing 21 types of rubber compositions for a tire (Standard Examples 1 to 3, Examples 1 to 21, and Comparative Examples 1 to 18) containing the common additive formulation indicated in Table 7 and having the blends indicated in Tables 1 to 6, components other than sulfur and vulcanization accelerators were weighed and kneaded in a 1.7 L sealed Banbury mixer for 5 minutes. Then, a master batch was discharged outside the mixer and cooled at room temperature. The master batch was placed in the Banbury mixer, and a sulfur and vulcanization accelerators were then added and mixed to obtain each of the rubber compositions for a tire. In the tables, SBR-4 is an oil extended product having an oil extension amount of 25 parts by mass, and thus the blended amount without the oil-extending component is shown in parentheses in the lower part. Furthermore, the additive formulation in Table 7 is expressed as values in parts by mass per 100 parts by mass of the diene rubbers listed in Tables 1 to 6. Each of the rubber compositions for a tire of Examples 1 to 21 and Comparative Examples 1 to 18 described above is referred to as rubber composition A, and a rubber composition having the same composition as that of the rubber composition A except that all the thermoplastic resin contained in the rubber composition A was replaced with oil is referred to as rubber composition B. Furthermore, a mixture was prepared by blending the diene rubber and the thermoplastic resin constituting the rubber composition for a tire of each of the Examples and the Comparative Examples at a mass ratio of 1:1, the glass transition temperature (Tgm) of the mixture was measured by the above-described method, the theoretical glass transition temperature Tga was calculated, and the difference Tga−Tgm of Tga from the measured glass transition temperature Tgm was calculated and shown in Tables 1 to 6.

The rubber composition for a tire obtained as described above was vulcanized at 160° C. for 20 minutes in a mold having a predetermined form, and thus an evaluation sample was produced. Using the obtained evaluation sample, dynamic visco-elasticity (loss tangent tan δ) and wear resistance were measured by the following methods. Further, a tire having a size of 205/55R16 in which the obtained rubber composition for a tire was used in a tire tread was vulcanization-molded, and the wet grip performance, the dry performance, and the dry grip performance after heat aging were measured by the following methods.

### Dynamic Visco-Elasticity (Loss Tangent Tan δ)

The dynamic visco-elasticities of the evaluation samples of the obtained rubber composition for a tire (rubber composition A) and the rubber composition B were measured using a visco-elastic spectrometer available from Iwamoto Seisakusho Co., Ltd. under conditions of an elongation deformation strain rate of 10±2%, a vibration frequency of 20 Hz, and a temperature of from −40° C. to 60° C.; a visco-elastic curve at from −40° C. to 60° C. was prepared; and tan δ_{MAXA}/tan δ_{MAXB} was calculated, where thickest values (peak values) of the tan δ of the rubber composition A and the rubber composition B were tan δ_{MAXA} and tan δ_{MAXB}. The obtained results are shown in Tables 1 to 6.

### Wear Resistance

Using a Lambourn abrasion test machine (available from Iwamoto Seisakusho K.K.), an amount of wear of the evaluation sample of the obtained rubber composition for a tire was measured in accordance with JIS (Japanese Industrial Standard) K6264 under the following conditions: a load of 15.0 kg (147.1 N) and a slip rate of 25%. A reciprocal for each of the obtained results was calculated, and shown in the rows of “wear resistance” in Tables 1 to 6 as an index value with a reciprocal of the amount of wear of Standard Example 1 being assigned the value of 100 in Tables 1 to 2, a reciprocal of the amount of wear of Standard Example 2 being assigned the value of 100 in Tables 3 to 4, and a reciprocal of the amount of wear of Standard Example 3 being assigned the value of 100 in Tables 5 to 6. A larger index value of wear resistance means superior wear resistance.

### Wet Grip Performance

The obtained tires were assembled on standard rims and mounted on a test vehicle equipped with ABS (Anti-lock Braking System) and having an engine displacement of 2000 cc, and the air pressures of the front tire and the rear tire were set to 220 kPa. The test vehicle was driven on an asphalt road surface sprinkled with water to a water depth of from 2.0 to 3.0 mm, and a braking stop distance from a speed of 100 km/h was measured. Each of the obtained results was expressed as an index value obtained by calculating a reciprocal thereof, and shown in the rows of “wet performance” in Tables 1 to 6 with a value of Standard Example 1 being assigned the value of 100 in Table 1, a value of Standard Example 2 being assigned the value of 100 in Tables 3 to 4, and a value of Standard Example 3 being assigned the value of 100 in Tables 5 to 6. A larger index value means superior wet grip performance.

### Dry Grip Performance

The obtained tires were assembled on standard rims and mounted on a test vehicle equipped with ABS and having an engine displacement of 2000 cc, and the air pressures of the front tire and the rear tire were set to 220 kPa. The test vehicle was driven on a relatively not so uneven dry road surface, and a braking stop distance from a speed of 100 km/h was measured. Each of the obtained results was expressed as an index value obtained by calculating a reciprocal thereof, and shown in the rows of “dry performance” in Tables 1 to 6 with a value of Standard Example 1 being assigned the value of 100 in Tables 1 to 2, a value of Standard Example 2 being assigned the value of 100 in Tables 3 to 4, and a value of Standard Example 3 being assigned the value of 100 in Tables 5 to 6. A larger index value means superior dry grip performance.

Dry Grip Performance after Heat Aging

The obtained tires were subjected to heat aging treatment at 70° C. for 7 days. The dry grip performance after heat aging was evaluated in the same manner as the dry grip performance described above except that the tires after heat aging treatment were used. Each of the obtained results was expressed as an index value obtained by calculating a reciprocal thereof, and shown in the rows of “dry performance after heat aging” in Tables 1 to 6 with a value of Standard Example 1 being assigned the value of 100 in Tables 1 to 2, a value of Standard Example 2 being assigned the value of 100 in Tables 3 to 4, and a value of Standard Example 3 being assigned the value of 100 in Tables 5 to 6. A larger index value means superior dry grip performance after heat aging.

TABLE 1-1

| | | | Com- | Com- | Com- |
|---|---|---|---|---|---|
| | | Standard | parative | parative | parative |
| | | Exam- | Exam- | Exam- | Exam- |
| | | ple 1 | ple 1 | ple 2 | ple 3 |
| NR | Parts by mass | | | | |
| SBR-1 | Parts by mass | 70 | 100 | 30 | 60 |
| SBR-2 | Parts by mass | 30 | | 70 | 40 |
| SBR-3 | Parts by mass | | | | |
| SBR-4 | Parts by mass | | | | |
| BR | Parts by mass | | | | |
| Carbon black | Parts by mass | 10 | 10 | 10 | 10 |
| Silica | Parts by mass | 100 | 100 | 100 | 100 |
| Coupling agent | Parts by mass | 9 | 9 | 9 | 9 |
| Resin-1 | Parts by mass | | | 45 | 10 |
| Resin-2 | Parts by mass | | | | |
| Resin-3 | Parts by mass | | | | |
| Resin-4 | Parts by mass | | 45 | | |
| Resin-5 | Parts by mass | | | | |
| Oil | Parts by mass | 45 | | | 35 |
| Difference | ° C. | — | 25 | 8 | 4 |
| Tga-Tgm | | | | | |
| Ratio tan δ_{MAXA}/ | — | — | 0.4 | 0.8 | 0.97 |
| tan δ_{MAXB} | | | | | |
| Wear Resistance | Index value | 100 | 60 | 91 | 100 |
| Wet performance | Index value | 100 | 100 | 122 | 100 |
| Dry performance | Index value | 100 | 95 | 110 | 100 |
| Dry performance | Index value | 100 | 120 | 120 | 100 |
| after heat aging | | | | | |

TABLE 1-2

| | | Com- | Com- | Com- |
|---|---|---|---|---|
| | | parative | parative | parative |
| | | Example 4 | Example 5 | Example 6 |
| NR | Parts by mass | | | |
| SBR-1 | Parts by mass | 100 | | |
| SBR-2 | Parts by mass | | | |
| SBR-3 | Parts by mass | | 100 | |
| SBR-4 | Parts by mass | | | 125 |
| | | | | (100) |
| BR | Parts by mass | | | |
| Carbon black | Parts by mass | 10 | 10 | 10 |
| Silica | Parts by mass | 100 | 100 | 100 |
| Coupling agent | Parts by mass | 9 | 9 | 9 |
| Resin-1 | Parts by mass | | 45 | 45 |
| Resin-2 | Parts by mass | | | |
| Resin-3 | Parts by mass | | | |
| Resin-4 | Parts by mass | | | |
| Resin-5 | Parts by mass | 45 | | |
| Oil | Parts by mass | | | |
| Difference Tga-Tgm | ° C. | 16 | 4 | 4 |
| Ratio tan δ_{MAXA}/tan | — | 0.64 | 0.81 | 0.83 |
| δ_{MAXB} | | | | |
| Wear Resistance | Index value | 88 | 85 | 88 |
| Wet performance | Index value | 100 | 125 | 115 |
| Dry performance | Index value | 98 | 110 | 105 |
| Dry performance after | Index value | 120 | 120 | 110 |
| heat aging | | | | |

TABLE 2-1

| | | Exam- | Exam- | Exam- | Exam- |
|---|---|---|---|---|---|
| | | ple 1 | ple 2 | ple 3 | ple 4 |
| NR | Parts by mass | | | | 20 |
| SBR-1 | Parts by mass | 100 | 80 | 60 | 80 |
| SBR-2 | Parts by mass | | 20 | 40 | |
| SBR-3 | Parts by mass | | | | |
| SBR-4 | Parts by mass | | | | |
| BR | Parts by mass | | | | |
| Carbon black | Parts by mass | 10 | 10 | 10 | 10 |
| Silica | Parts by mass | 100 | 100 | 100 | 100 |
| Coupling agent | Parts by mass | 9 | 9 | 9 | 9 |
| Resin-1 | Parts by mass | 45 | 37 | 25 | 45 |
| Resin-2 | Parts by mass | | | | |
| Resin-3 | Parts by mass | | | | |
| Resin-4 | Parts by mass | | | | |
| Oil | Parts by mass | | 8 | 20 | |
| Difference | ° C. | 3 | 4 | 5 | 4 |
| Tga-Tgm | | | | | |
| Ratio tan δ_{MAXA}/ | — | 0.85 | 0.88 | 0.91 | 0.83 |
| tan δ_{MAXB} | | | | | |
| Wear Resistance | Index value | 125 | 115 | 104 | 121 |
| Wet performance | Index value | 112 | 108 | 104 | 102 |
| Dry performance | Index value | 118 | 114 | 108 | 109 |
| Dry performance | Index value | 120 | 114 | 101 | 120 |
| after heat aging | | | | | |

TABLE 2-2

| | | Example 5 | Example 6 | Example 7 |
|---|---|---|---|---|
| NR | Parts by mass | | | |
| SBR-1 | Parts by mass | 80 | 100 | 100 |
| SBR-2 | Parts by mass | | | |
| SBR-3 | Parts by mass | | | |
| SBR-4 | Parts by mass | | | |
| BR | Parts by mass | 20 | | |
| Carbon black | Parts by mass | 10 | 10 | 10 |
| Silica | Parts by mass | 100 | 100 | 100 |
| Coupling agent | Parts by mass | 9 | 9 | 9 |
| Resin-1 | Parts by mass | 45 | | |
| Resin-2 | Parts by mass | | 45 | |
| Resin-3 | Parts by mass | | | 35 |
| Resin-4 | Parts by mass | | | |
| Oil | Parts by mass | | | 10 |
| Difference Tga-Tgm | ° C. | 4 | 3 | 4 |
| Ratio tan δ_{MAXA}/ | — | 0.81 | 0.86 | 0.89 |
| tan δ_{MAXB} | | | | |
| Wear Resistance | Index value | 132 | 122 | 130 |
| Wet performance | Index value | 101 | 109 | 112 |
| Dry performance | Index value | 105 | 117 | 137 |
| Dry performance | Index value | 120 | 120 | 111 |
| after heat aging | | | | |

TABLE 3-1

| | | | Com- | Com- | Com- |
|---|---|---|---|---|---|
| | | Standard | parative | parative | parative |
| | | Exam- | Exam- | Exam- | Exam- |
| | | ple 2 | ple 7 | ple 8 | ple 9 |
| NR | Parts by mass | | | | |
| SBR-1 | Parts by mass | 70 | 100 | 30 | 60 |
| SBR-2 | Parts by mass | 30 | | 70 | 40 |
| SBR-3 | Parts by mass | | | | |
| SBR-4 | Parts by mass | | | | |
| BR | Parts by mass | | | | |
| Carbon black | Parts by mass | 10 | 10 | 10 | 10 |
| Silica | Parts by mass | 130 | 130 | 130 | 130 |
| Coupling agent | Parts by mass | 11 | 11 | 11 | 11 |
| Resin-1 | Parts by mass | | | 45 | 10 |
| Resin-2 | Parts by mass | | | | |
| Resin-3 | Parts by mass | | | | |
| Resin-4 | Parts by mass | | 45 | | |
| Resin-5 | Parts by mass | | | | |
| Oil | Parts by mass | 45 | | | 35 |
| Difference Tga-Tgm | ° C. | — | 25 | 8 | 4 |
| Ratio tan δ_{MAXA}/ | — | — | 0.4 | 0.8 | 0.97 |
| tan δ_{MAXB} | | | | | |
| Wear Resistance | Index value | 100 | 60 | 91 | 100 |
| Wet performance | Index value | 100 | 100 | 122 | 100 |
| Dry performance | Index value | 100 | 95 | 110 | 100 |
| Dry performance | Index value | 100 | 120 | 120 | 100 |
| after heat aging | | | | | |

TABLE 3-2

| | | Com- | Com- | Com- |
|---|---|---|---|---|
| | | parative | parative | parative |
| | | Example 10 | Example 11 | Example 12 |
| NR | Parts by mass | | | |
| SBR-1 | Parts by mass | 100 | | |
| SBR-2 | Parts by mass | | | |
| SBR-3 | Parts by mass | | 100 | |
| SBR-4 | Parts by mass | | | 125 |
| | | | | (100) |
| BR | Parts by mass | | | |
| Carbon black | Parts by mass | 10 | 10 | 10 |
| Silica | Parts by mass | 130 | 130 | 130 |
| Coupling agent | Parts by mass | 11 | 11 | 11 |
| Resin-1 | Parts by mass | | 45 | 45 |
| Resin-2 | Parts by mass | | | |
| Resin-3 | Parts by mass | | | |
| Resin-4 | Parts by mass | | | |
| Resin-5 | Parts by mass | 45 | | |
| Oil | Parts by mass | | | |
| Difference | ° C. | 16 | 4 | 4 |
| Tga-Tgm | | | | |
| Ratio tan δ_{MAXA}/ | — | 0.64 | 0.81 | 0.83 |
| tan δ_{MAXB} | | | | |
| Wear Resistance | Index value | 88 | 85 | 88 |
| Wet performance | Index value | 100 | 125 | 115 |
| Dry performance | Index value | 98 | 110 | 105 |
| Dry performance | Index value | 120 | 120 | 110 |
| after heat aging | | | | |

TABLE 4-1

| | | Exam- | Exam- | Exam- | Exam- |
|---|---|---|---|---|---|
| | | ple 8 | ple 9 | ple 10 | ple 11 |
| NR | Parts by mass | | | | 20 |
| SBR-1 | Parts by mass | 100 | 80 | 60 | 80 |
| SBR-2 | Parts by mass | | 20 | 40 | |
| SBR-3 | Parts by mass | | | | |
| SBR-4 | Parts by mass | | | | |
| BR | Parts by mass | | | | |
| Carbon black | Parts by mass | 10 | 10 | 10 | 10 |
| Silica | Parts by mass | 130 | 130 | 130 | 130 |
| Coupling agent | Parts by mass | 11 | 11 | 11 | 11 |
| Resin-1 | Parts by mass | 45 | 37 | 25 | 45 |
| Resin-2 | Parts by mass | | | | |
| Resin-3 | Parts by mass | | | | |
| Resin-4 | Parts by mass | | | | |
| Oil | Parts by mass | | 8 | 20 | |
| Difference Tga-Tgm | ° C. | 3 | 4 | 5 | 4 |
| Ratio tan δ_{MAXA}/ | — | 0.85 | 0.88 | 0.91 | 0.83 |
| tan δ_{MAXB} | | | | | |
| Wear Resistance | Index value | 125 | 115 | 104 | 121 |
| Wet performance | Index value | 112 | 108 | 104 | 102 |
| Dry performance | Index value | 118 | 114 | 108 | 109 |
| Dry performance | Index value | 120 | 114 | 102 | 120 |
| after heat aging | | | | | |

TABLE 4-2

| | | Exam- | Exam- | Exam- |
|---|---|---|---|---|
| | | ple 12 | ple 13 | ple 14 |
| NR | Parts by mass | | | |
| SBR-1 | Parts by mass | 80 | 100 | 100 |
| SBR-2 | Parts by mass | | | |
| SBR-3 | Parts by mass | | | |
| SBR-4 | Parts by mass | | | |
| BR | Parts by mass | 20 | | |
| Carbon black | Parts by mass | 10 | 10 | 10 |
| Silica | Parts by mass | 130 | 130 | 130 |
| Coupling agent | Parts by mass | 11 | 11 | 11 |
| Resin-1 | Parts by mass | 45 | | |
| Resin-2 | Parts by mass | | 45 | |
| Resin-3 | Parts by mass | | | 35 |
| Resin-4 | Parts by mass | | | |
| Oil | Parts by mass | | | 10 |
| Difference Tga-Tgm | ° C. | 4 | 3 | 4 |
| Ratio tan δ_{MAXA}/ | — | 0.81 | 0.86 | 0.89 |
| tan δ_{MAXB} | | | | |
| Wear Resistance | Index value | 132 | 122 | 130 |
| Wet performance | Index value | 101 | 109 | 112 |
| Dry performance | Index value | 105 | 117 | 137 |
| Dry performance | Index value | 120 | 120 | 111 |
| after heat aging | | | | |

TABLE 5-1

| | | | Com- | Com- | Com- |
|---|---|---|---|---|---|
| | | Standard | parative | parative | parative |
| | | Exam- | Exam- | Exam- | Exam- |
| | | ple 3 | ple 13 | ple 14 | ple 15 |
| NR | Parts by mass | | | | |
| SBR-1 | Parts by mass | 70 | 100 | 30 | 60 |
| SBR-2 | Parts by mass | 30 | | 70 | 40 |
| SBR-3 | Parts by mass | | | | |
| SBR-4 | Parts by mass | | | | |
| BR | Parts by mass | | | | |
| Carbon black | Parts by mass | 10 | 10 | 10 | 10 |
| Silica | Parts by mass | 70 | 70 | 70 | 70 |
| Coupling agent | Parts by mass | 6 | 6 | 6 | 6 |
| Resin-1 | Parts by mass | | | 45 | 10 |
| Resin-2 | Parts by mass | | | | |
| Resin-3 | Parts by mass | | | | |
| Resin-4 | Parts by mass | | 45 | | |
| Resin-5 | Parts by mass | | | | |
| Oil | Parts by mass | 45 | | | 35 |
| Difference Tga-Tgm | ° C. | — | 25 | 8 | 4 |
| Ratio tan δ_{MAXA}/tan | — | — | 0.4 | 0.8 | 0.97 |
| δ_{MAXB} | | | | | |
| Wear Resistance | Index value | 100 | 60 | 91 | 100 |
| Wet performance | Index value | 100 | 100 | 122 | 100 |
| Dry performance | Index value | 100 | 95 | 110 | 100 |
| Dry performance | Index value | 100 | 120 | 120 | 100 |
| after heat aging | | | | | |

TABLE 5-2

| | | Com- | Com- | Com- |
|---|---|---|---|---|
| | | parative | parative | parative |
| | | Exam- | Exam- | Exam- |
| | | ple 16 | ple 17 | ple 18 |
| NR | Parts by mass | | | |
| SBR-1 | Parts by mass | 100 | | |
| SBR-2 | Parts by mass | | | |
| SBR-3 | Parts by mass | | 100 | |
| SBR-4 | Parts by mass | | | 125 |
| | | | | (100) |
| BR | Parts by mass | | | |
| Carbon black | Parts by mass | 10 | 10 | 10 |
| Silica | Parts by mass | 70 | 70 | 70 |
| Coupling agent | Parts by mass | 6 | 6 | 6 |
| Resin-1 | Parts by mass | | 45 | 45 |
| Resin-2 | Parts by mass | | | |
| Resin-3 | Parts by mass | | | |
| Resin-4 | Parts by mass | | | |
| Resin-5 | Parts by mass | 45 | | |
| Oil | Parts by mass | | | |
| Difference Tga-Tgm | ° C. | 16 | 4 | 4 |
| Ratio tan δ_{MAXA}/tan | — | 0.64 | 0.81 | 0.83 |
| δ_{MAXB} | | | | |
| Wear Resistance | Index value | 88 | 85 | 88 |
| Wet performance | Index value | 100 | 125 | 115 |
| Dry performance | Index value | 98 | 110 | 105 |
| Dry performance after | Index value | 120 | 120 | 110 |
| heat aging | | | | |

TABLE 6-1

| | | Exam- | Exam- | Exam- | Exam- |
|---|---|---|---|---|---|
| | | ple 15 | ple 16 | ple 17 | ple 18 |
| NR | Parts by mass | | | | 20 |
| SBR-1 | Parts by mass | 100 | 80 | 60 | 80 |
| SBR-2 | Parts by mass | | 20 | 40 | |
| SBR-3 | Parts by mass | | | | |
| SBR-4 | Parts by mass | | | | |
| BR | Parts by mass | | | | |
| Carbon black | Parts by mass | 10 | 10 | 10 | 10 |
| Silica | Parts by mass | 70 | 70 | 70 | 70 |
| Coupling agent | Parts by mass | 6 | 6 | 6 | 6 |
| Resin-1 | Parts by mass | 45 | 35 | 25 | 45 |
| Resin-2 | Parts by mass | | | | |
| Resin-3 | Parts by mass | | | | |
| Resin-4 | Parts by mass | | | | |
| Oil | Parts by mass | | 10 | 20 | |
| Difference Tga-Tgm | ° C. | 3 | 4 | 5 | 4 |
| Ratio tan δ_{MAXA}/tan | — | 0.85 | 0.88 | 0.91 | 0.83 |
| δ_{MAXB} | | | | | |
| Wear Resistance | Index value | 125 | 115 | 104 | 121 |
| Wet performance | Index value | 112 | 108 | 104 | 102 |
| Dry performance | Index value | 118 | 114 | 108 | 109 |
| Dry performance after | Index value | 120 | 114 | 102 | 120 |
| heat aging | | | | | |

TABLE 6-2

| | | Exam- | Exam- | Exam- |
|---|---|---|---|---|
| | | ple 19 | ple 20 | ple 21 |
| NR | Parts by mass | | | |
| SBR-1 | Parts by mass | 80 | 100 | 100 |
| SBR-2 | Parts by mass | | | |
| SBR-3 | Parts by mass | | | |
| SBR-4 | Parts by mass | | | |
| BR | Parts by mass | 20 | | |
| Carbon black | Parts by mass | 10 | 10 | 10 |
| Silica | Parts by mass | 70 | 70 | 70 |
| Coupling agent | Parts by mass | 6 | 6 | 6 |
| Resin-1 | Parts by mass | 45 | | |
| Resin-2 | Parts by mass | | 45 | |
| Resin-3 | Parts by mass | | | 35 |
| Resin-4 | Parts by mass | | | |
| Oil | Parts by mass | | | 10 |
| Difference Tga-Tgm | ° C. | 4 | 3 | 4 |
| Ratio tan δ_{MAXA}/tan | — | 0.81 | 0.86 | 0.89 |
| δ_{MAXB} | | | | |
| Wear Resistance | Index value | 132 | 122 | 130 |
| Wet performance | Index value | 101 | 109 | 112 |
| Dry performance | Index value | 105 | 117 | 137 |
| Dry performance after | Index value | 120 | 120 | 111 |
| heat aging | | | | |

Types of raw materials used as indicated in Tables 1 to 6 are described below.
NR: Natural rubber; TSR 20; glass transition temperature: −65° C.
SBR-1: Terminal-modified styrene-butadiene rubber having a polyorganosiloxane structure; Nipol NS612, available from Zeon Corporation; glass transition temperature: −61° C.; styrene monomer-derived unit: 8.4 mol %; vinyl monomer-derived unit: 28.4 mol %; non-oil extended product
SBR-2: Terminal-modified styrene-butadiene rubber having a polyorganosiloxane structure; Nipol NS616, available from Zeon Corporation; glass transition temperature: −23° C.; styrene monomer-derived unit: 12.8 mol %; vinyl monomer-derived unit: 58.4 mol %; non-oil extended product
SBR-3: Terminal-modified solution-polymerized styrene-butadiene rubber manufactured by batch polymerization; HPR850, available from JSR Corporation; glass transition temperature: −25° C.; styrene monomer-derived unit: 16.1 mol %; vinyl monomer-derived unit: 49.5 mol %; non-oil extended product
SBR-4: Alkoxysilane-modified solution-polymerized styrene-butadiene rubber manufactured by continuous polymerization; M2520, available from LG; glass transition temperature: −48° C.; styrene monomer-derived unit: 16.1 mol %; vinyl monomer-derived unit: 22.7 mol %; oil extension amount: 25 parts by mass.
BR: Butadiene rubber; Nipol BR1220, available from Zeon Corporation; glass transition temperature: −105° C.
Carbon black: SEAST 7HM, available from Tokai Carbon Co., Ltd.
Silica: Zeosil 1165MP, available from Solvay; nitrogen adsorption specific surface area: 159 m²/g
Coupling agent: Silane coupling agent; Si69, available from Evonik Degussa
Resin-1: Aromatic modified terpene resin; HSR-7, available from Yasuhara Chemical Co., Ltd.; glass transition temperature: 72° C.
Resin-2: Aromatic modified terpene resin; YS resin TO-105, available from Yasuhara Chemical Co., Ltd.; glass transition temperature: 57° C.
Resin-3: Indene resin; FMR0150, available from Mitsui Chemicals, Inc.; glass transition temperature: 89° C.
Resin-4: Phenol modified terpene resin; Tamanol 803L, available from Arakawa Chemical Industries, Ltd.; glass transition temperature: 95° C.
Resin-5: Polyterpene resin; Sylvatraxx8115, available from Kraton Corporation; glass transition temperature: 67° C.
Oil: Extract 4S, available from Shell Lubricants Japan K.K.

TABLE 7
Common additive formulation

| | | |
|---|---|---|
| Anti-aging agent | 3.0 | Parts by mass |
| Wax | 1.0 | Parts by mass |
| Sulfur | 2.0 | Parts by mass |
| Vulcanization accelerator | 1.5 | Parts by mass |

Types of raw materials used as indicated in Table 7 are described below.
Anti-aging agent: VULANOX 4020, available from Lanxess AG
Wax: OZOACE-0015A, available from Nippon Seiro Co., Ltd.
Sulfur: SULFAX 5, available from Tsurumi Chemical Industry Co., Ltd.
Vulcanization accelerator: NOCCELER CZ-G, available from Ouchi Shinko Chemical Industrial Co., Ltd.

As can be seen from Tables 2, 4 and 6, it was confirmed that the rubber compositions for a tire of Examples 1 to 21 achieved excellent wear resistance, wet performance, dry performance, and grip performance after heat aging.

As is clear from Table 1, the rubber composition for a tire of Comparative Example 1 has a difference Tga−Tgm exceeding 10° C. and tan δ_{MAXA}/tan δ_{MAXB} of 0.8 or less, and thus has low wear resistance and low dry performance.

The rubber composition for a tire of Comparative Example 2 contains less than 55 parts by mass of the specific styrene-butadiene rubber, and thus has low wear resistance.

The rubber composition for a tire of Comparative Example 3 contains less than 15 parts by mass of the specific thermoplastic resin, and thus cannot have improved wear resistance, wet performance, dry performance, or dry grip performance after heat aging.

The rubber composition for a tire of Comparative Example 4 has a difference Tga−Tgm exceeding 10° C. and tan δ_{MAXA}/tan δ_{MAXB} of 0.8 or less, and thus has low wear resistance and low dry performance.

The rubber composition for a tire of Comparative Example 5 has low wear resistance because the Tg of the styrene-butadiene rubber (SBR-3) is higher than −55° C., and the total amount of the styrene monomer-derived unit and the vinyl monomer-derived unit in the styrene-butadiene rubber is more than 50 mol %.

The rubber composition for a tire of Comparative Example 6 has low wear resistance because the Tg of the styrene-butadiene rubber (SBR-4) is higher than −55° C.

As is clear from Table 3, the rubber composition for a tire of Comparative Example 7 has a difference Tga−Tgm exceeding 10° C. and tan δ_{MAXA}/tan δ_{MAXB} of 0.8 or less, and thus has low wear resistance and low dry performance.

The rubber composition for a tire of Comparative Example 8 contains less than 55 parts by mass of the specific styrene-butadiene rubber, and thus has low wear resistance.

The rubber composition for a tire of Comparative Example 9 contains less than 15 parts by mass of the specific thermoplastic resin, and thus cannot have improved wear resistance, wet performance, dry performance, or dry grip performance after heat aging.

The rubber composition for a tire of Comparative Example 10 has a difference Tga−Tgm exceeding 10° C. and tan δ_{MAXA}/tan δ_{MAXB} of 0.8 or less, and thus has low wear resistance and low dry performance.

The rubber composition for a tire of Comparative Example 11 has low wear resistance because the Tg of the styrene-butadiene rubber (SBR-3) is higher than −55° C., and the total amount of the styrene monomer-derived unit and the vinyl monomer-derived unit in the styrene-butadiene rubber is more than 50 mol %.

The rubber composition for a tire of Comparative Example 12 has low wear resistance because the Tg of the styrene-butadiene rubber (SBR-4) is higher than −55° C.

As is clear from Table 5, the rubber composition for a tire of Comparative Example 13 has a difference Tga−Tgm exceeding 10° C. and tan δ_{MAXA}/tan δ_{MAXB} of 0.8 or less, and thus has low wear resistance and low dry performance.

The rubber composition for a tire of Comparative Example 14 contains less than 55 parts by mass of the specific styrene-butadiene rubber, and thus has low wear resistance.

The rubber composition for a tire of Comparative Example 15 contains less than 15 parts by mass of the specific thermoplastic resin, and thus cannot have improved wear resistance, wet performance, dry performance, or dry grip performance after heat aging.

The rubber composition for a tire of Comparative Example 16 has a difference Tga−Tgm exceeding 10° C. and tan δ_{MAXA}/tan δ_{MAXB} of 0.8 or less, and thus has low wear resistance and low dry performance.

The rubber composition for a tire of Comparative Example 17 has low wear resistance because the Tg of the styrene-butadiene rubber (SBR-3) is higher than −55° C., and the total amount of the styrene monomer-derived unit and the vinyl monomer-derived unit in the styrene-butadiene rubber is more than 50 mol %.

The rubber composition for a tire of Comparative Example 18 has low wear resistance because the Tg of the styrene-butadiene rubber (SBR-4) is higher than −55° C.

1. A rubber composition for a tire, comprising:
100 parts by mass of a diene rubber comprising 55 mass % or more of a styrene-butadiene rubber; and
15 parts by mass or more of a thermoplastic resin,
the styrene-butadiene rubber having a glass transition temperature of −55° C. or lower, a total amount of a styrene monomer-derived unit and a vinyl monomer-derived unit in the styrene-butadiene rubber being 50 mol % or lower, and the diene rubber and the thermoplastic resin satisfying relationships (i) and (ii) below:
(i) a difference Tga−Tgm between Tga and Tgm is 10° C. or less, where Tga is a theoretical glass transition temperature of a mixture in which the diene rubber and the thermoplastic resin are blended at a mass ratio of 1:1, the theoretical glass transition temperature Tga of the mixture being calculated from glass transition temperatures of the diene rubber and the thermoplastic resin, and Tgm is a measured glass transition temperature of the mixture; and
(ii) a maximum value tan δ_{MAXA} of a loss tangent at from −40° C. to 60° C. of the rubber composition for a tire and a maximum value tan δ_{MAXB} of a loss tangent at from −40° C. to 60° C. of a rubber composition B having the same composition as that of the rubber composition for a tire except that all the thermoplastic resin is replaced with oil such that it satisfies tan δ_{MAXA}/δ_{MAXB}>0.8 in relation to the rubber composition B.

2. The rubber composition for a tire according to claim 1, wherein a total amount of the oil contained in the rubber composition for a tire is less than 10 parts by mass per 100 parts by mass of the diene rubber.

3. The rubber composition for a tire according to claim 1, wherein at least one terminal of the styrene-butadiene rubber is modified with a functional group.

4. The rubber composition for a tire according to claim 1, wherein the thermoplastic resin has a glass transition temperature of from 40° C. to 120° C.

5. The rubber composition for a tire according to claim 1, wherein the thermoplastic resin is at least one selected from the group consisting of resins composed of at least one selected from terpenes, modified terpenes, rosins, rosin esters, C5 components, and C9 components, and resins in which at least some of double bonds of these resins are hydrogenated.

6. The rubber composition for a tire according to claim 1, wherein an oil extension amount of the styrene-butadiene rubber is 10 parts by mass or less per 100 parts by mass of the styrene-butadiene rubber.

7. A tire comprising: a tread portion comprising the rubber composition for a tire according to claim 1.

8. The rubber composition for a tire according to claim 2, wherein at least one terminal of the styrene-butadiene rubber is modified with a functional group.

9. The rubber composition for a tire according to claim 8, wherein the thermoplastic resin has a glass transition temperature of from 40° C. to 120° C.

10. The rubber composition for a tire according to claim 9, wherein the thermoplastic resin is at least one selected from the group consisting of resins composed of at least one selected from terpenes, modified terpenes, rosins, rosin esters, C5 components, and C9 components, and resins in which at least some of double bonds of these resins are hydrogenated.

11. The rubber composition for a tire according to claim 10, wherein an oil extension amount of the styrene-butadiene rubber is 10 parts by mass or less per 100 parts by mass of the styrene-butadiene rubber.

12. A tire comprising: a tread portion comprising the rubber composition for a tire according to claim 11.
